(19) United States
(12) Patent Application Publication
(10) Pub. No.: US 2012/0103142 A1
(43) Pub. Date: May 3, 2012

(54) POWERED WRENCH

(76) Inventor: John S. Sroka, Richfield, OH (US)

(21) Appl. No.: 13/286,949

(22) Filed: Nov. 1, 2011

Related U.S. Application Data
(60) Provisional application No. 61/409,213, filed on Nov. 2, 2010.

(51) Int. Cl. B25B 21/00

(52) U.S. Cl. 81/57.11; 81/57; 81/57.3; 81/57.29

(57) ABSTRACT

A powered wrench is provided comprising a head formed with an open end, and defining a rotational axis extending through the head. An engaging member is seated in a recess for rotation about the rotational axis, and comprises an outer surface provided with a plurality of gear teeth. A plurality of drive gears transfers input torque from motive structure to the engaging member for driving rotation of the engaging member about the rotational axis. A plurality of auxiliary idler gears is arranged between the plurality of drive gears and the gear teeth of the engaging member such that at least one auxiliary idler gear is always engaged with the gear teeth of the engaging member.

### CROSS-REFERENCE TO RELATED APPLICATIONS

This application claims the benefit of U.S. Provisional Application No. 61/409,213, filed Nov. 2, 2010, the entire disclosure of which is hereby incorporated herein by reference.

### FIELD OF THE INVENTION

The present invention relates generally to a powered wrench for tightening or loosening nuts, bolts, fasteners, and the like.

### BACKGROUND OF THE INVENTION

Wrenches are well known. Most wrenches utilize a socket, where the socket includes an opening formed in the shape of a specific fastener size, for example, a half inch hexagonal bolt or a 14 mm twelve point bolt head. Most wrenches are sold with a variety of sockets, each socket designed to fit a specific sized bolt or nut.

In such wrenches, the wrench includes structure for securing the socket to a mechanism such that a variety of sockets may be interchangeably attached to the wrench. In recent years, wrenches and sockets have been standardized where the wrench includes a protruding shank that is ⅜ inch square and the socket has a ⅜ inch square opening to accommodate the shank. Other standard size wrench shanks are ¼ inch square and ½ inch square with the sockets having corresponding ¼ inch square and ½ inch square openings.

Open end wrenches have been used for over a century. Open end wrenches typically have a U-shaped opening at one end with opposed parallel faces that are manufactured to fit one single bolt or nut size. Open end wrenches allow a technician or handyman to engage a bolt or nut when only a radial face of the bolt or nut is exposed. A drawback to an open end wrench is that the user must constantly remove the wrench from the bolt or nut and reposition the wrench in order to tighten or loosen the bolt or nut.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a powered wrench is provided, comprising a head formed with an open end, a recess, and a rotational axis that extends through the recess. An engaging member is seated in the recess for rotation about the rotational axis, comprising a radially extending outer surface that is generally parallel to the rotational axis. The outer surface is provided with a plurality of gear teeth. A plurality of drive gears transfers input torque from motive structure to the engaging member for driving rotation of the engaging member about the rotational axis. A plurality of auxiliary idler gears is arranged between the plurality of drive gears and the gear teeth of the engaging member and driven by at least one of the plurality of drive gears. The plurality of auxiliary idler gears is arranged within the head such that at least one auxiliary idler gear is always engaged with the gear teeth of the engaging member.

In accordance with another aspect of the present invention, a powered wrench is provided, comprising a head formed with an open end, a recess, and a rotational axis that extends through the recess. An engaging member is seated in the recess for rotation about the rotational axis, comprising a radially extending outer surface that is generally parallel to the rotational axis. The outer surface is provided with a plurality of gear teeth. A plurality of drive gears transfers input torque from motive structure to the engaging member for driving rotation of the engaging member about the rotational axis. A plurality of auxiliary idler gears is arranged between the plurality of drive gears and the gear teeth of the engaging member. The plurality of auxiliary idler gears is arranged within the head such that at least one auxiliary idler gear is always engaged with the gear teeth of the engaging member to enable the engaging member to continuously rotate 360 degrees about the rotational axis. The plurality of gear teeth of the engaging member extends along an arcuate extent greater than about 180 degrees on the outer surface of the engaging member.

In accordance with another aspect of the present invention, a powered wrench is provided, comprising a head formed with a gap defining an open end, and a recess with a rotational axis that extends through the recess. An engaging member is seated in the recess for rotation about the rotational axis and comprising an open potion generally corresponding to the gap of the head. The engaging member further comprises a radially extending outer surface that is generally parallel to the rotational axis. The outer surface is provided with a plurality of gear teeth. A plurality of drive gears transfers input torque from motive structure to the engaging member for driving rotation of the engaging member about the rotational axis. First and second auxiliary idler gears are arranged between the plurality of drive gears and the gear teeth of the engaging member. The first and second auxiliary idler gears are arranged on opposite lateral sides of the engaging member. The first and second auxiliary idler gears are configured such that at least one of the first and second auxiliary idler gears is always engaged with the gear teeth of the engaging member when the other of the first and second auxiliary idler gears is received within the open portion of the engaging member.

It is to be understood that both the foregoing general description and the following detailed description present example and explanatory embodiments of the invention, and are intended to provide an overview or framework for understanding the nature and character of the invention as it is claimed. The accompanying drawings are included to provide a further understanding of the invention and are incorporated into and constitute a part of this specification. The drawings illustrate various example embodiments of the invention, and together with the description, serve to explain the principles and operations of the invention.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a perspective of an example powered wrench;

FIG. 2 is a top view of the powered wrench of FIG. 1;

FIG. 3 is a side view of the powered wrench of FIG. 1;

FIG. 4 is similar to FIG. 2, but with portions of the housing removed for clarity;

FIG. 5 is similar to FIG. 3, but with portions of the housing removed for clarity;

FIG. 6 is a perspective of another example powered wrench;

FIG. 7 is a top view of the powered wrench of FIG. 6;

FIG. 8 is a side view of the powered wrench of FIG. 6;

FIG. 9 is similar to FIG. 7, but with portions of the housing removed for clarity; and

FIGS. 10-19 show a variety of example inserts that can be inserted into the engaging member of the powered wrench.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

Attached hereto is U.S. Pat. No. 4,573,377 entitled “Lightweight Power Wrench” by John Sroka. The attached document is part of this patent application and is incorporated herein by reference thereto. Herein, the attached document may be referred to as “the '377 patent.”

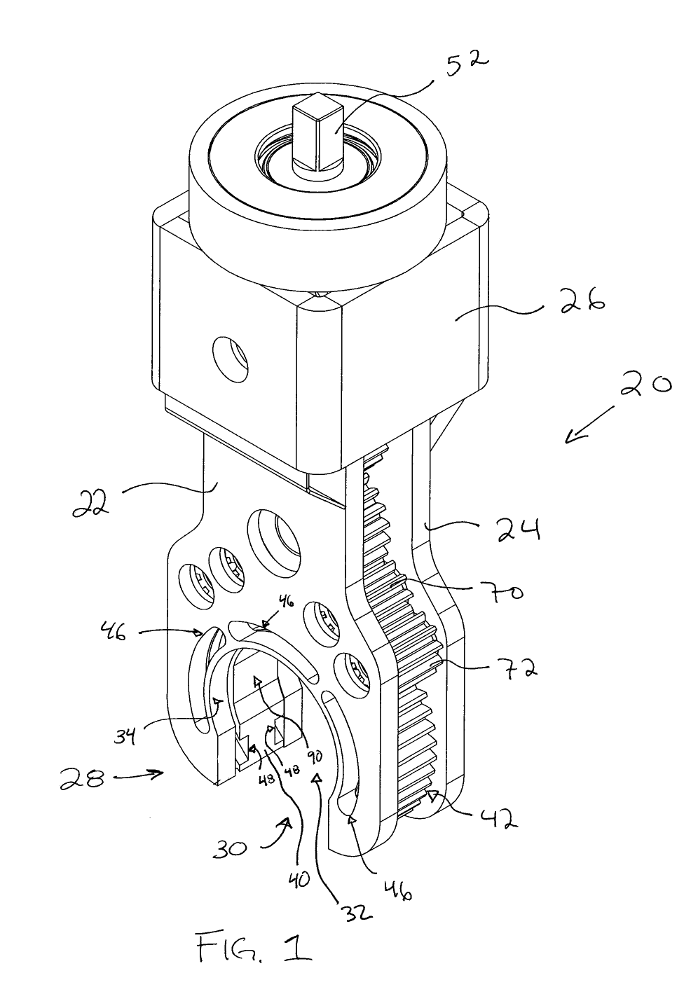

Turning to the shown example of FIG. 1, an example powered wrench 20 is provided for use with a work piece. The term “work piece” as used herein, generally refers to any fastener arrangement that can be used to fasten or secure structural members in an automotive, construction, or any other application where such a fastener might be used. The components of such a work piece may include a pair of cables, a pair of rods or bars, or a pair of one and the other, with a fastening means securing one end of a cable or a rod to another end of a cable or a rod, though various elements are contemplated. Most prevalent fastening means is the internally threaded nuts and turnbuckles having a pair of spaced nut elements.

The powered wrench 20 can include a housing, including closed or open configurations. In one example, the housing can include at least two plates 22, 24 that are disposed in an opposing evenly spaced relationship to each other. The plates 22, 24 can be secured in a spaced relationship by spacers or the like arranged therebetween, such as around the periphery of the housing plates, and are secured thereto, as by mechanical fasteners and/or welding. The spacing between the plates can generally correspond to the thickness of the internal gears and/or other structure. In one example, a relative more rugged configuration can include a heavier, open design with large gear teeth, while a relatively less rugged configuration can include a lighter, closed design with small gear teeth, though various other combinations are contemplated.

The powered wrench 20 can generally include a handle portion 26 provided at suitable locations to facilitate handling of the wrench, and at least one head 28 formed at an end of the handle portion 26. In another example, not shown, the handle portion can include at least two heads disposed on opposite ends of the handle. The handle portion 26 may include structure to enable a user to hold the wrench, such as a tapered configuration to facilitate gripping by a user, and/or may include clamping structure, coupling structure, gripping structure or the like for interaction with structure other than a user's hand (e.g., insertion of rods or bars, etc.) for the purpose of facilitating holding and stabilizing the wrench when in use.

The head 28 of the wrench can be provided with similar or different structure and/or functions that include, but are not limited to: an open end; a closed end; a fixed aperture sized for interacting with a fixed-size fastener; a rotatable (and/or ratcheting) aperture sized for interacting with a fixed-size fastener; a fixed aperture sized for interacting with an interchangeable insert for different-size fasteners; and/or a rotatable (and/or ratcheting) aperture sized for interacting with an interchangeable insert for different-size fasteners. The interchangeable insert can also be referred to as a collet, which can be formed of one or more elements.

In the shown example, the head 28 is formed with a gap 30 that defines an open end. The head 28 is also formed with a recess 32 on an inner surface thereof that provides a side wall 34 having generally cylindrical contour. The cylindrical contour of the side wall 34 is formed about an axis 36 that extends generally through the center of the head 28. The head 28, gap 30, recess 32, and/or side wall 34 can be machined to a relatively tight tolerance, such as to about 0.001 inches or other value. The gap 30 has a width and the engaging member 40 has an outer diameter, the width of the gap 30 being less than the outer diameter of the engaging member 40 to an amount sufficient to inhibit the engaging member 40 from inadvertent removal from the recess of the head 28.

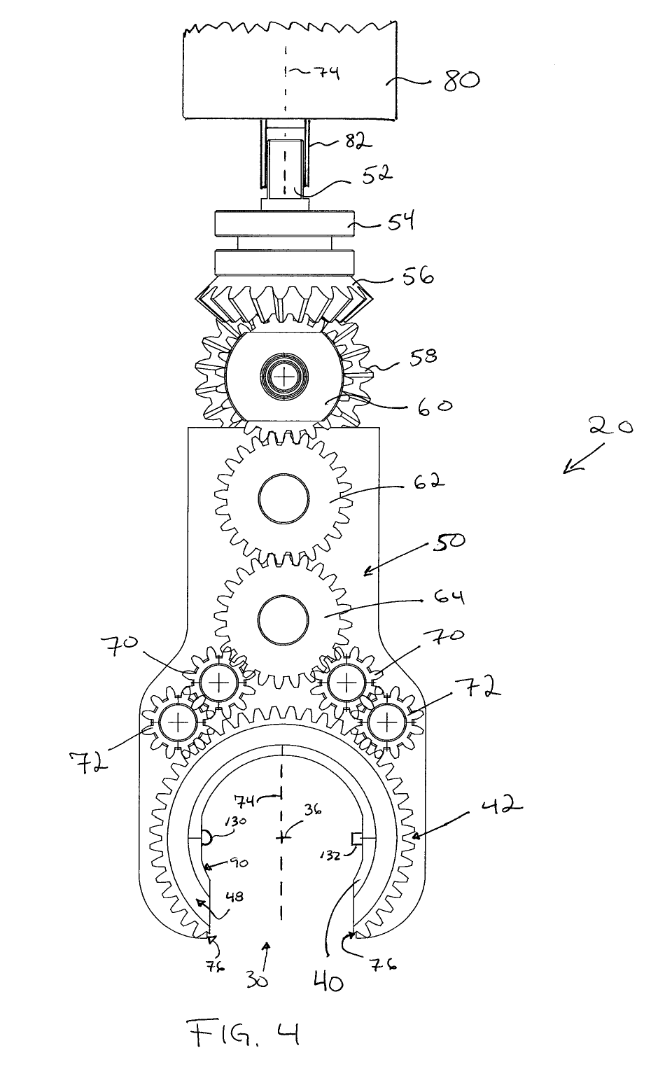

As described herein, any head 28 of the wrench 20 can include structure that enables at least a portion of the head, such as an engaging member 40, to rotate relative to the handle portion 26. The rotation can occur in one or more directions. Rotatable within one head 28 is the engaging member 40 (see FIG. 4), having a generally C-shaped geometry and appropriate gear teeth 42 extending about at least a portion, such as entirely, about the peripheral edge to facilitate rotation of the engaging member 40 about the axis 36 that passes through the head 28. The gear teeth 42 of the C-shaped engaging member 40 can form a major gear section of a generally circular gear. In one example, the major gear section can have an arcuate extent greater than about 180 degrees, such as about 270 degrees (though other angles are contemplated). The engaging member 40 can include an open potion generally corresponding to the gap 30 of the head 28.

The engaging member 40 can be retained within the head 28 in various manners, such as by a spring clip, fasteners, or the like. In one example, the engaging member 40 can be retained within the head 28 by a one or more key elements 44 received in corresponding keyways 46 of the wrench 20. The engaging member 40 can have a generally continuous circumferential groove 48 on either or both of its faces (i.e., top and/or bottom faces) that traverses the major gear section. For example, as shown, three keyways 46 are shown arranged along a circumferential path defined by an imaginary circle. Keyways 46 extend through at least one of the top and bottom plates 22, 24 and corresponding keyways, not shown, can be provided in the other of the top and bottom plates 22, 24. Although three keyways 46 are shown, any number can be provided. It can be beneficial to extend the keyways 46 such that they extend along an arcuate length greater than 180 degrees on the imaginary circle. This condition can enable the engaging member 40 to maintain a continuous rotary condition via the key elements 44 that are disposed within keyways 46. Still, where the keyways 46 do not extend along an arcuate length greater than 180 degrees, additional structure can be provided to secure the engaging member 40 within housing.

Each key element 44 can be elongated and/or arcuate to be nestled in the groove 48 of the engaging member 40. The thickness of key element 44 can be such as to protrude through the housing plate(s) 22, 24 and into the circumferential groove 48 in the engaging member 40. To facilitate turning or rotation of the engaging member 40 on the key elements 44, the cooperating structural elements can be designed to provide for smooth sliding motion between the groove(s) 48 and the key elements 44 and for a relatively long life of such elements. For example, the cooperating surfaces can be made of different metals or the same metal whereby one surface is made of a harder metal and the other surface is made of a softer metal. Since the key elements 44 can easily be removed and changed, the key elements 44 can be made of a softer metal relative to the metal surface in the gear groove(s) 48, or vice versa. In one example, the key elements 44 can be formed of aluminum bronze, such as SAE 660, though various other materials are contemplated.

In order to turn a work piece, a suitable motive structure can be used to impart torque to a drive system which transmits the torque to the engaging member 40. Various arrangements of the drive system can be used. In one example, the drive system can include a plurality of gears 50 arranged in a gear train. The plurality of gears 50 can be referred to as a plurality of drive gears. Various types and/or combinations of gears can be used. For example, the drive system can utilize spur gears, bevel gears, worm gears, crown gears, and/or any other type of gears. It should be understood that drive system can utilize the drive train to modify, such as increase or decrease, the input torque and/or rotational speed imparted for rotating or turning the engaging member 40. For example, a 2:1 ratio can be used so as to substantially double the input torque, though various other ratios are contemplated. Cooperating structure can be provided on either the drive shaft or drive system to secure the components for rotation in unison. In addition or alternatively, solid and/or flexible drive shaft arrangements are also contemplated.

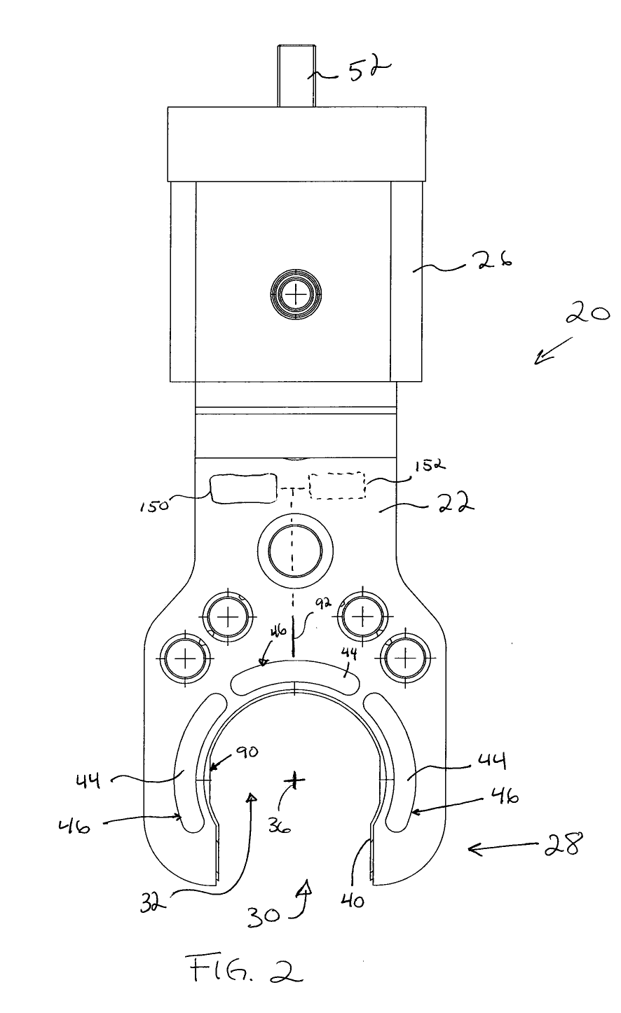

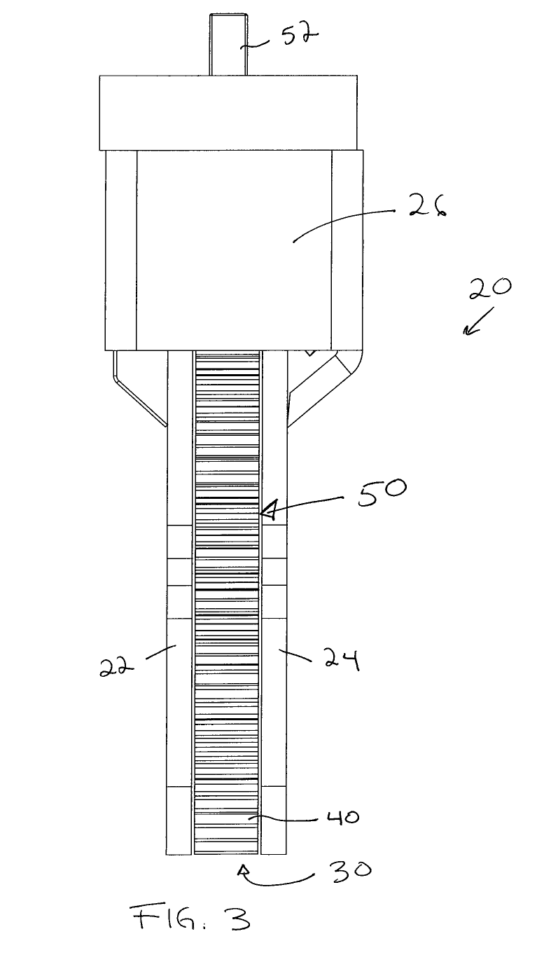

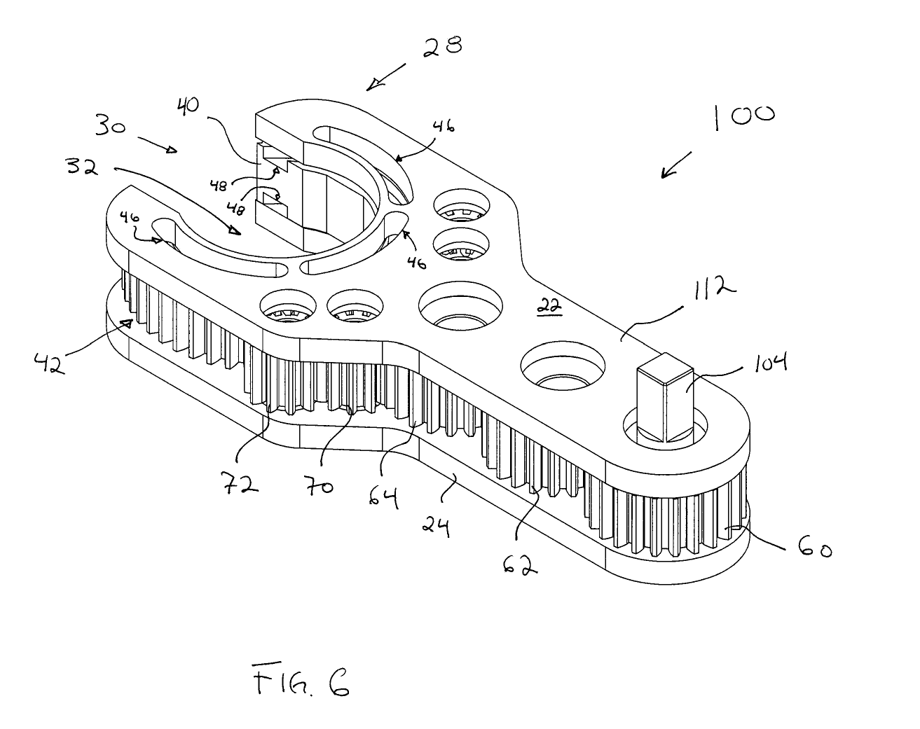

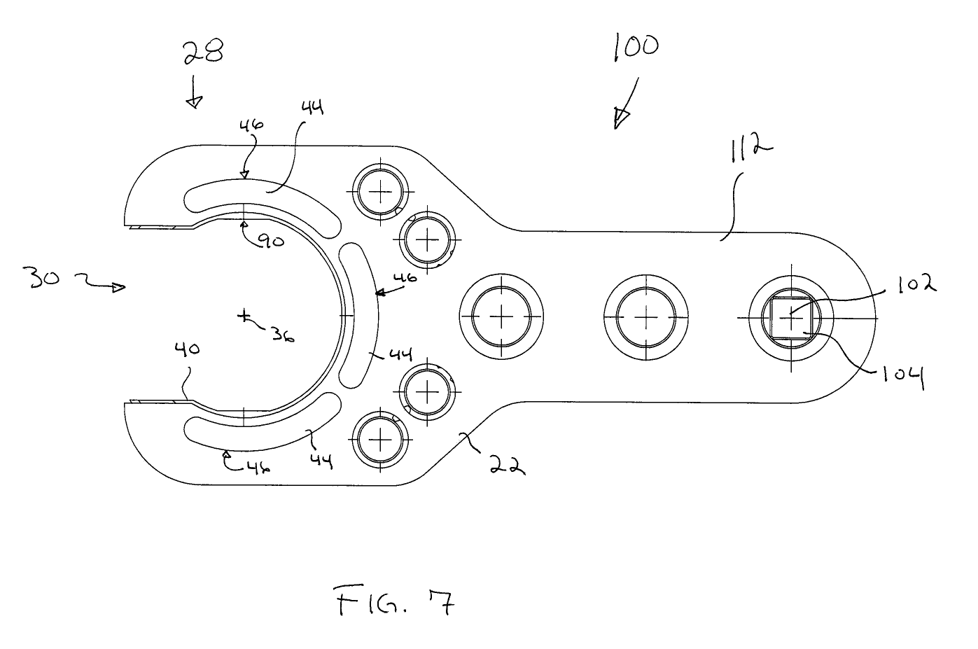

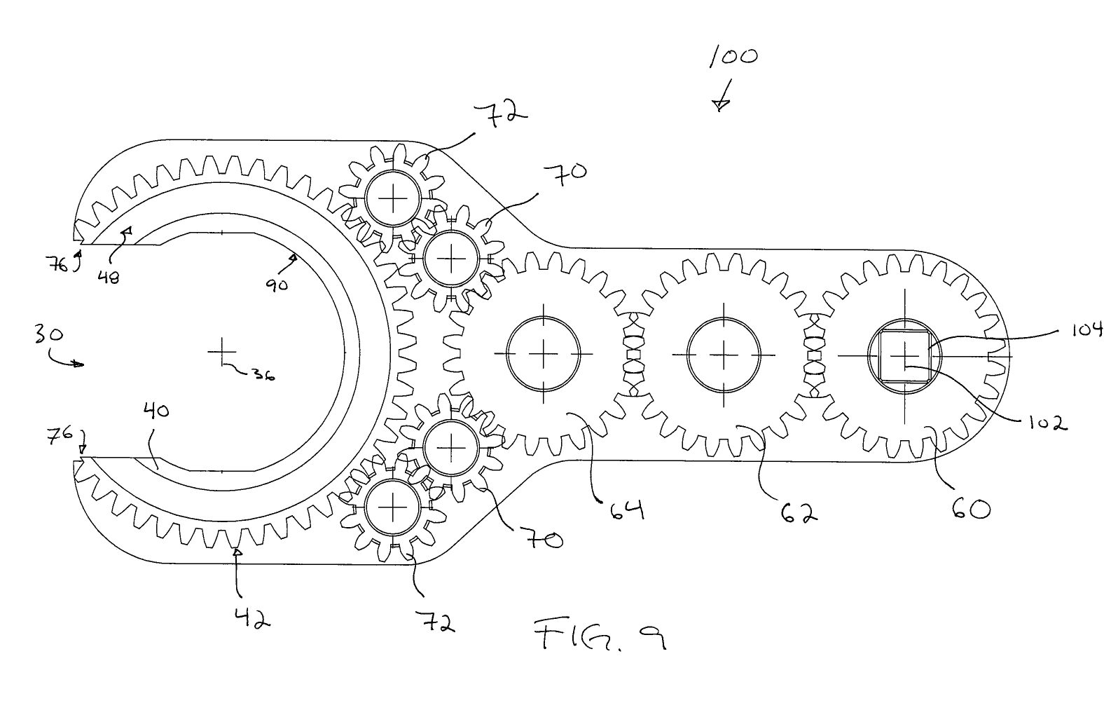

As described herein, the drive system can include a plurality of gears 50 arranged in a gear train for use with motive structure that is arranged variously. In one example, shown in FIGS. 1-5, the gear train can be arranged such that the rotational axis of the engaging member 40 is generally perpendicular to the rotational axis of the motive structure (i.e., horizontal drive arrangement). In another example, shown in FIGS. 6-9, the gear train can be arranged such that the rotational axis of the engaging member 40 is generally parallel to the rotational axis of the motive structure (i.e., vertical drive arrangement). Various other angled arrangements are also contemplated.

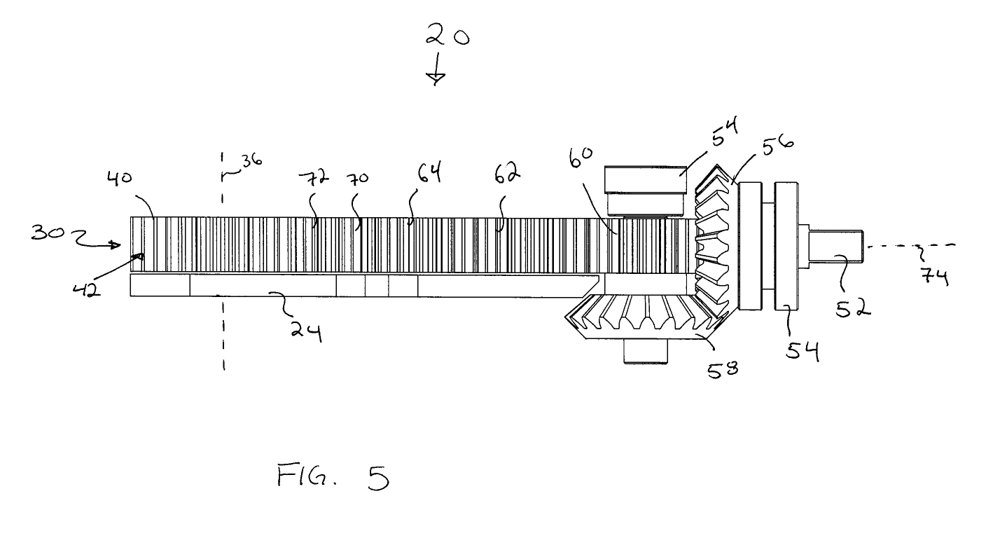

Turning to FIGS. 4-5, where various portions of the housing (i.e., top plate 22 and handle portion 26) are removed for clarity, one example plurality of gears 50 is shown. The illustrated plurality of gears 50 includes different types of gears, such as bevel gears, worm gears, and/or spur gears, due to the input drive shaft 52 being arranged generally perpendicular to the axis 36 of the engaging member 40. For example, the input drive shaft 52 is connected to a first bevel gear 56 that is engaged with a second (driven) bevel gear 58 that is arranged perpendicularly. In addition or alternatively, the various gears 50 of the gear train can be provided on various rotational shafts or the like for support within the powered wrench 20, and various rotational supports 54 (e.g., bearings, bushings, etc.) can be utilized and may be coupled to the various top and bottom plates 22, 24 and/or handle portion 26. Similarly, the various rotational shafts of the gears can be carried via the various top and bottom plates 22, 24 and/or handle portion 26.

An input spur gear 60 is arranged and vertically spaced on the rotational axis of the second bevel gear 58 to rotate together therewith. Additional idler spur gears 62, 64 are engaged with the input spur gear 60 to transmit the rotational torque along the length of the powered wrench 20. Various numbers and configuration of gears are contemplated depending upon the physical size, geometry, etc. of the powered wrench 20.

In one embodiment, not shown, the final spur gear (i.e., gear 64) could directly engage and drive the gear teeth 42 of the engaging member 40. However, this would limit the rotational angle of the engaging member 40 once the open portion encountered the teeth of said final spur gear 64, whereupon the lack of gear teeth 42 in the open portion would not provide for further rotation of the engaging member 40.

Thus, it can be beneficial to configure the gear train of the drive system so as to enable the engaging member 40 to rotate a full 360 degrees, despite the open portion, and provide a functional open-end wrench. In one example, a plurality of auxiliary idler gears 70, 72 can be utilized that are concurrently driven by an upstream drive gear, such as the final spur gear 64. The plurality of auxiliary idler gears 70, 72 can be positioned laterally on both sides of the engaging member 40, such as in a mirrored arrangement. Where the gear teeth 42 of the engaging member 40 have an arcuate extent greater than 180 degrees, the plurality of auxiliary idler gears 70, 72 can be sized and/or positioned within the head 28, taking into account the width of the open portion, such that at least some of the gear teeth of the auxiliary idler gears 70, 72 are always engaged with the gear teeth 42 of the engaging member 40. For example, the auxiliary idler gears 70, 72 can be positioned relatively farther away from a centerline 74 of the tool relative to the arcuate ends 76 of the engaging member 40. In other words, at least one of the plurality of auxiliary idler gears 70, 72 can be positioned laterally outwards of the arcuate ends 76 of the gear teeth 42 of the engaging member 40. Thus, when the engaging member 40 rotates about the axis 36, at least one arcuate end 76 of the gear teeth 42 will be driven by at least one of the idler gears 70, 72 to permit the engaging member 40 to continuously rotate a full 360 degrees. Additionally, where two sets of auxiliary idler gears 70, 72 are used, one set of the auxiliary idler gears 70, 72 will be engaging a major portion of the gear teeth 42 while the other set of the auxiliary idler gears 70, 72 will be engaging one of the arcuate ends 76. As a result, the input torque from the input drive shaft 52 is continuously transmitted to the engaging member 40.

Any desired motive structure 80 can be applied to provide the motive force to the engaging member 40. The motive structure 80 includes a drive member 82 configured to engage the input drive shaft 52 directly, or indirectly through an adapter (not shown), for driving the powered wrench 20. The motive structure 80 can be in the form of an ordinary drill, an impact wrench, engines, electric motors, pneumatic systems, hydraulic systems, a worm gear, and/or any other structure (including user-applied force via another wrench or ratchet) for providing input torque to turn the engaging member 40. The motive structure 80 can be independent of and removable from the powered wrench 20. Still, during use, the motive structure 80 can be secured to the powered wrench 20 to reduce relative motion therebetween. Alternatively, the motive structure 80 can even be formed with the powered wrench 20. Appropriate associated user controls and/or power supplies can be provided. Where the motive structure is independent and removable, suitable coupling structure can be provided to couple the motive structure 80 to various portions of the powered wrench 20, such as to the plates 22, 24, handle portion 26, etc. Various portions of the motive structure 80 can be removed, such as motors, batteries, etc. Recharging structure and/or various other energy supply structure can also be provided. It is contemplated that the powered wrench 20 can generally be a hand-held tool, though it is also contemplated that it can be supported on a stand or the like.

In addition or alternatively, the engaging member 40 can be adapted to receive a plurality of interchangeable inserts to increase the usability and convenience of the powered wrench 20. The interchangeable insert can also be referred to as a collet, which can be formed of one or more elements. Various types of collets can be provided. For example, a variety of insert collets are depicted in the drawings and pictures. One example can be a socket having a square recess and a round recess which coact with a key and/or ball detente, respectively, so that any one of the variety of sockets may be selected and used with the powered wrench. Another example insert collet can include a hexagonal (or other polygonal) recess for engaging a correspondingly shaped fastener, etc. Yet another example insert collet can include a pipe-wrench structure having an interior edge formed with a plurality of teeth for providing grip, etc. Various other closed or open end insert collet structure is contemplated.

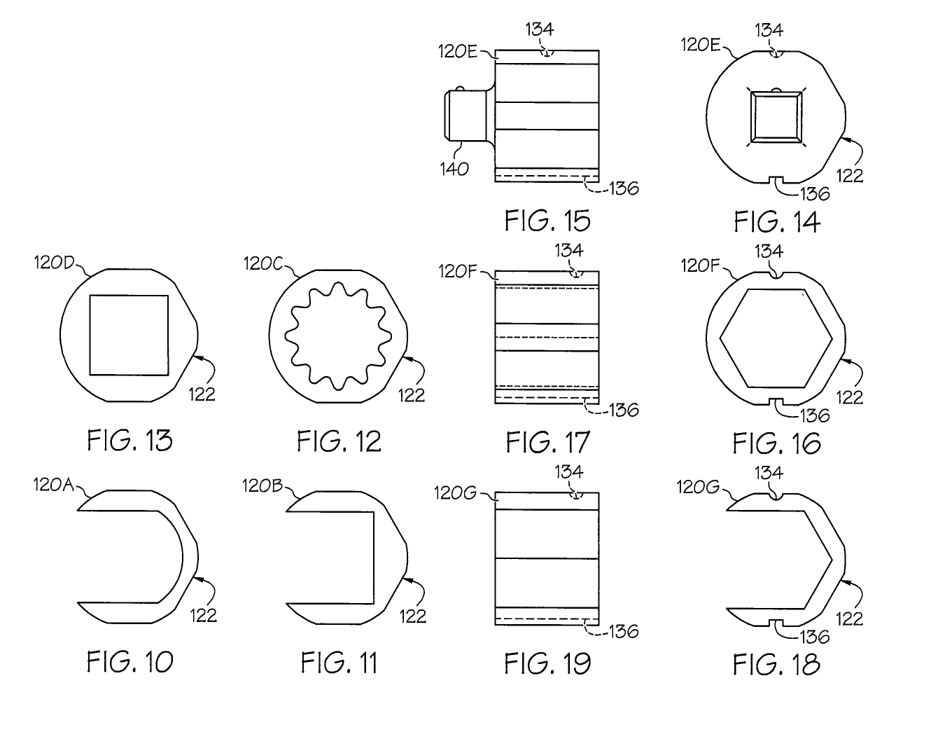

A variety of wrench inserts 120A-120G are depicted in FIGS. 10-19. Each of the inserts 120A-120G can have various open-end or closed-end geometries, sizes, and can be adapted to interact with various mechanical fasteners, other tools, etc. The inserts 120A-120G can each have coupling structure to engage with the inner surface 90 of the engaging member 40 so that any one of the variety of inserts may be operably retained by the engaging member 40 and used with the powered wrench 20. The various inserts can be similar to those described in U.S. Pat. No. 5,388,479 entitled Universal Ratchet Wrench by John Sroka, which is incorporated herein by reference thereto.

In one example, as shown in FIGS. 10-19, the coupling structure of the engaging member 40 and inserts 120A-120G can include corresponding geometry adapted to retain the interchangeable inserts via a relatively tight fit. For example, the inner surface 90 can have a predetermined, keyed shape and the wrench inserts 120A-120G can have a similar geometry. Such a keyed shape can facilitate correct insertion of the inserts, as well as inhibiting, such as preventing, inadvertent relative rotation between the inserts and the engaging member 40. The geometry of the outer surface 122 of the inserts can correspond to the inner surface 90 of the engaging member 40. The corresponding geometry can include various tapers or the like adapted to facilitate retaining the interchangeable inserts. Though one geometry is shown, it is understood that the inner surface 90 and outer surface 122 can also have various other geometries. The inner surface 90 can have at least two, such as three or four, major supporting surfaces for the interchangeable inserts 120A-120G.

In addition or alternatively, the coupling structure can include a keyed structure. In one example, as shown in FIGS. 14-19, the engaging member 40 can be provided with a spring loaded ball detente 130 and/or a key 132 (see FIG. 4) and the interchangeable inserts can be similarly provided with a round recess 134 and/or a square recess 136 to coact with the key and the ball detente, respectively. Thus, torque is transmitted to the engaging member 40 can carry the collet therewith. The work piece, which is secure within the collet, is also turned in such a fashion.

In addition or alternatively, the wrench 20 can be provided with a converting attachment (see FIGS. 14-15), such as insert 120E, that includes a standard square drive shank 140 for use with various sockets. The drive shank 140 may be any of the standard sizes such as a three-eighths inch drive or a one-half inch drive thus enabling the wrench to be used with the standard socket sets widely used by both backyard mechanics and professional mechanics.

Turning now to FIGS. 6-9, an alternate powered wrench 100 is shown. It is understood that any of the structure described in FIGS. 1-5 can be similarly used with the alternate powered wrench 100. As such, similar identification numbers are used to indicate similar or identical structure. Finally, though not shown, it is further contemplated that the gear train can be adapted to operate with the motive structure arranged at various other angles.

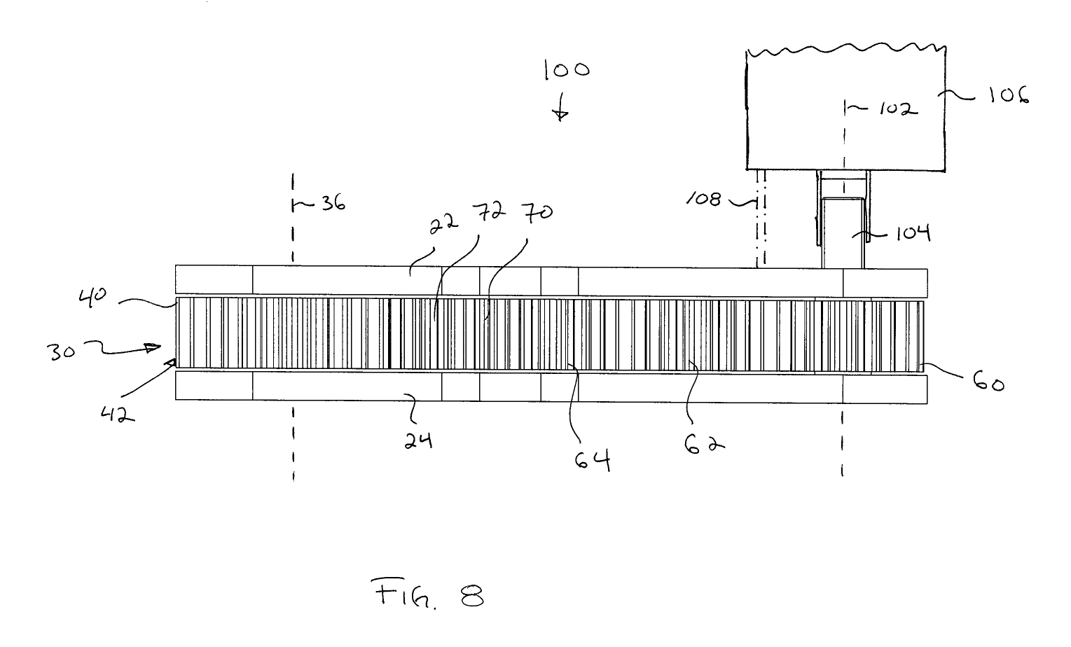

As can be appreciated, it can be beneficial to provide a tool with a different drive arrangement due to the numerous applications and space constraints found in different operating environments. The alternate powered wrench 100 can have a gear train arranged such that the rotational axis 36 (see FIG. 8) of the engaging member 40 is generally parallel to the rotational axis 102 of the input drive shaft 104 and/or motive structure 106 (i.e., vertical drive arrangement). Thus, the alternate powered wrench 100 can be used in a more space-restricted environment. Similar motive structure 106 can be utilized as previously described herein. Additionally, coupling structure 108 (illustrated schematically) can be provided to removably or non-removably couple the motive structure 106 to the handle portion 26 or top/bottom plate 22, 24.

Various arrangements of the drive system can be used. In one example, the drive system can include a plurality of gears 110 arranged in a gear train that can be similar or different than those previously discussed herein. Various types and/or combinations of gears can be used. Because the rotational axis 36 of the engaging member 40 is generally parallel to the rotational axis 102 of the input drive shaft 104, the input spur gear 60 can directly receive input torque from motive structure 106 without using the previously-described bevel gear arrangement. Thus, drive losses can be reduced and reliability improved via a reduction in moving parts. Further, due to the removal of the bevel gears, the handle portion 112 can be tapered and/or reduced in size relative to the previously described powered wrench 20 to provide a more convenient and/or comfortable hand grip.

Additionally, a plurality of auxiliary idler gears 70, 72 can be utilized that are concurrently driven by an upstream drive gear, such as the final spur gear 64. The plurality of auxiliary idler gears 70, 72 can be positioned on both sides of the engaging member 40 to permit the engaging member 40 to continuously rotate a full 360 degrees, as previously described herein. A similar engaging member 40 with gear teeth 42 can be utilized, and similar interchangeable inserts 120A-120G can be utilized.

Various other features can also be provided for the powered wrenches 20, 100. For example, various portions of the powered wrench 20 can include alignment indicia 92, such as one or more lines, that can visually indicate when the C-shaped engaging member 40 is oriented at a desired rotational position. For example, each of the C-shaped engaging member 40 (and/or collet) and the top plate 22 can each include a line that, when in alignment, indicates that an open end of the C-shaped engaging member 40 corresponds to the open end (e.g., the gap 30) of the head 28. Still other alignment indicators can be used, including mechanical, electrical, analog and/or digital structure, displays, sound, etc.

In addition or alternatively, any of the head(s) can be arranged at an angle and/or offset relative to the handle portion. Suitable gearing arrangements are contemplated for transferring input torque to the head(s). In one example, a head can be arranged at an angle of approximately 15 degrees relative to the longitudinal axis of the handle portion. In another example, a portion of the handle can be bent such that the head is vertically offset a distance from the handle portion.

In addition or alternatively, the wrench can include torque sensing structure for indicating (i.e., visual, audible, tactile, etc.) and/or controlling an amount of torque that can be applied by the wrench, such as structure found on a torque wrench or the like. In one example, the torque sensing structure 152 (see FIG. 1) can operate to limit a maximum amount of torque that can be applied by the wrench 20. The torque sensing structure 152 can include a mechanical or electronic clutch or the like that can inhibit, such as prevent, the wrench 20 from applying torque greater than a predetermined or user-definable limit. For example, the torque sensing structure 152 can be applied to one or more heads of the wrench, or even variously along the gear train, and can include mechanical, electrical, analog and/or digital structure, displays, sound, etc. In one example, the torque sensing structure 152 can be operatively coupled to a mechanical or electronic display 150 to display the actual, sensed torque applied by the wrench 20, 100. The display 150 can maximum and/or minimum readings, predetermined or user-definable alarm limits, etc.

In addition or alternatively, it is contemplated that a minor gear section (not shown) can be coupled to the engaging member 40 to complete the circular shaped gear to a full 360 degrees. The minor gear section may be similar to that described in U.S. Pat. No. 4,573,377. The major and minor gear sections can be removably or non-removably secured together in various manners, such as by pins passing therethrough, other mechanical structure, adhesives, welding, etc. For example, the minor gear section can have complementary openings that align with similar openings in the major gear section when the two gear sections are in assembled condition. The engaging sections of the respective gear sections can be disposed over each other in a cooperative and mating relationship. In another example, the minor gear section can be pivotally coupled to the major gear section to permit insertion of an object to be rotated, an insert, etc., without complete removal of the minor section.

In addition or alternatively, any head of the wrench can include ratcheting structure (not shown) that can enable the engaging member 40 to perform at least one function, at least two functions, at least three functions, at least four functions, or even more functions. In one example, the ratcheting structure can be configured to allow the engaging member to rotate in one direction only, such as clockwise (“CW” function) or counter-clockwise (“CCW” function), while inhibiting rotation in the opposite direction. In another example, the ratcheting structure can be configured to allow the engaging member to rotate in both directions CW and CCW (“neutral” function). In yet another example, the ratcheting structure can be configured to inhibit the engaging member from rotating in either direction (“lock” or “stationary” function).

In addition or alternatively, though not shown, a double ended wrench can have two open ends. Either or both of the ends can be powered, and a suitable gear arrangement can be provided for driving either or both ends independently or concurrently. For example, the ends may be of differing sizes to accommodate differing sized inserts or sockets, thus increasing the number of wrench sizes that may be accommodated by a single handle tool. For example, one end may be configured to handle sockets for bolt sizes five-eighths inch up to one inch (i.e., 15 mm up to 26 mm) and the other end may accommodate sizes one-quarter of an inch up to five-eighths of an inch (i.e., 4 mm up to 15 mm), though various other sizes are contemplated. The gear arrangements used in the wrenches depicted in the drawings could be any one or combinations of the example mechanisms described herein.

It should also be appreciated, that in each of the example embodiments described herein the C-shaped engaging member 40 may be provided with a fixed bolt-head engaging surface having configurations similar to the surfaces on the insertable sockets depicted. That is, the inner surface of the engaging member 40 can be provided as a fixed aperture sized for interacting with a particular, fixed-size fastener without the use of an interchangeable insert. Still, an interchangeable insert can still be used therewith for various other sized fasteners. In addition or alternatively, the engaging member 40 can be removable and replaceable, such as for maintenance, wear, and/or alternative sizing. For example, an engaging member 40 having a relatively larger inner surface for accommodating relatively larger inserts can be removed from the powered wrench 20 and replaced with another engaging member 40 having a relatively smaller inner surface for accommodating relatively smaller inserts.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A powered wrench, comprising:
a head formed with an open end, a recess, and a rotational axis that extends through the recess;
an engaging member seated in the recess for rotation about the rotational axis, comprising a radially extending outer surface that is generally parallel to the rotational axis, the outer surface being provided with a plurality of gear teeth;
a plurality of drive gears to transfer input torque from motive structure to the engaging member for driving rotation of the engaging member about the rotational axis; and
a plurality of auxiliary idler gears arranged between the plurality of drive gears and the gear teeth of the engaging member and driven by at least one of the plurality of drive gears, the plurality of auxiliary idler gears being arranged within the head such that at least one auxiliary idler gear is always engaged with the gear teeth of the engaging member.

2. The powered wrench of claim 1, wherein the plurality of drive gears are arranged such that the rotational axis of the engaging member is generally parallel to a rotational axis of the motive structure.

3. The powered wrench of claim 1, wherein the plurality of drive gears are arranged such that the rotational axis of the engaging member is generally perpendicular to a rotational axis of the motive structure.

4. The powered wrench of claim 3, wherein the plurality of drive gears comprises at least one bevel gear.

5. The powered wrench of claim 1, wherein the plurality of auxiliary idler gears are arranged within the head to enable the engaging member to continuously rotate 360 degrees about the rotational axis.

6. The powered wrench of claim 1, wherein the outer surface of the engaging member has an arcuate extent greater than about 180 degrees.

7. The powered wrench of claim 1, wherein the plurality of gear teeth of the engaging member extend along a predetermined radial distance of the outer surface of the engaging member such that the engaging member is permitted to rotate completely about the rotational axis with at least a portion of the gear teeth always in contact with gear teeth of at least one of the auxiliary idler gears.

8. The powered wrench of claim 1, wherein the engaging member has a generally continuous circumferential groove on its front face, and the engaging member is retained within the head by at least one key element received within the circumferential groove via a corresponding keyway of the wrench.

9. The powered wrench of claim 1, wherein the motive structure is coupled to a portion of the powered wrench.

10. The powered wrench of claim 1, further comprising a plurality of interchangeable inserts operably retainable within the engaging member, wherein the engaging member is adapted to retain the interchangeable members therein.

11. The powered wrench of claim 1, wherein the engaging member comprises a pair of arcuate ends, and wherein at least one of the plurality of auxiliary idler gears is positioned relatively farther away from a centerline of the powered wrench relative to the arcuate ends of the engaging member.

12. A powered wrench, comprising:
a head formed with an open end, a recess, and a rotational axis that extends through the recess;
an engaging member seated in the recess for rotation about the rotational axis, comprising a radially extending outer surface that is generally parallel to the rotational axis, the outer surface being provided with a plurality of gear teeth;
a plurality of drive gears to transfer input torque from motive structure to the engaging member for driving rotation of the engaging member about the rotational axis; and
a plurality of auxiliary idler gears arranged between the plurality of drive gears and the gear teeth of the engaging member, the plurality of auxiliary idler gears being arranged within the head such that at least one auxiliary idler gear is always engaged with the gear teeth of the engaging member to enable the engaging member to continuously rotate 360 degrees about the rotational axis,
wherein the plurality of gear teeth of the engaging member extend along an arcuate extent greater than about 180 degrees on the outer surface of the engaging member.

13. The powered wrench of claim 12, wherein the plurality of drive gears are arranged such that the rotational axis of the engaging member is generally parallel to a rotational axis of the motive structure.

14. The powered wrench of claim 12, wherein the plurality of drive gears are arranged such that the rotational axis of the engaging member is generally perpendicular to a rotational axis of the motive structure.

15. The powered wrench of claim 12, wherein the engaging member has a generally continuous circumferential groove on its front face, and the engaging member is retained within the head by at least one key element received within the circumferential groove via a corresponding keyway of the wrench.

16. A powered wrench, comprising:
a head formed with a gap defining an open end, and a recess with a rotational axis that extends through the recess;
an engaging member seated in the recess for rotation about the rotational axis and comprising an open potion generally corresponding to the gap of the head, and further comprising a radially extending outer surface that is generally parallel to the rotational axis, the outer surface being provided with a plurality of gear teeth;
a plurality of drive gears to transfer input torque from motive structure to the engaging member for driving rotation of the engaging member about the rotational axis; and
first and second auxiliary idler gears arranged between the plurality of drive gears and the gear teeth of the engaging member, the first and second auxiliary idler gears being arranged on opposite lateral sides of the engaging member,
wherein the first and second auxiliary idler gears are configured such that at least one of the first and second auxiliary idler gears is always engaged with the gear teeth of the engaging member when the other of the first and second auxiliary idler gears is received within the open portion of the engaging member.

17. The powered wrench of claim 16, wherein the plurality of gear teeth of the engaging member extend along an arcuate extent greater than about 180 degrees on the outer surface of the engaging member.

18. The powered wrench of claim 16, wherein the first and second auxiliary idler gears are arranged within the head to enable the engaging member to continuously rotate 360 degrees about the rotational axis

19. The powered wrench of claim 16, wherein the plurality of drive gears are arranged such that the rotational axis of the engaging member is generally parallel to a rotational axis of the motive structure.

20. The powered wrench of claim 16, wherein the plurality of drive gears are arranged such that the rotational axis of the engaging member is generally perpendicular to a rotational axis of the motive structure.
